(19) United States
(12) Patent Application Publication
(10) Pub. No.: US 2018/0305979 A1
(43) Pub. Date: Oct. 25, 2018

(54) MOTORIZED WINDOW COVERING HAVING POWERED MODULES

(71) Applicant: TTI (MACAO COMMERCIAL OFFSHORE) LIMITED, Macau (MO)

(72) Inventors: J. Porter Whitmire, Greenville, SC (US); Mark Huggins, Anderson, SC (US); Tanvi Singh, Pune (IN); J. Luke Jenkins, Anderson, SC (US)

(21) Appl. No.: 15/956,576

(22) Filed: Apr. 18, 2018

Related U.S. Application Data
(60) Provisional application No. 62/487,376, filed on Apr. 19, 2017.

(51) Int. Cl. E06B 9/70; E06B 9/42

(52) U.S. Cl. CPC E06B 9/70; E06B 9/42

(57) ABSTRACT

A window covering assembly includes one or more powered modules, such as a light, temperature sensor, fan, heater, or motion detector. The window covering assembly is configured so that the modules may be attached to the window covering assembly in numerous configurations, thus permitting tailored features of the window covering assembly.

This application claims the benefit of U.S. Provisional Application No. 62/487,376, filed Apr. 19, 2017, the contents of which are hereby incorporated by reference in their entirety.

### SUMMARY OF THE INVENTION

The present invention relates to a window covering assembly, and more particularly, to such an assembly that includes one or more powered modules. These modules may be a light, temperature sensor, fan, heater, or motion detector. A user is able to select the appropriate type and quantities of modules for a given window covering assembly.

### BRIEF DESCRIPTION OF THE DRAWING

FIG. 1 is an exploded view of a window covering assembly according to one exemplary embodiment of the present invention.

FIG. 2 is a side view of a window covering assembly according to one exemplary embodiment of the present invention.

FIG. 3 is a perspective view of a window covering assembly according to one exemplary embodiment of the present invention.

### DETAILED DESCRIPTION OF THE PREFERRED EMBODIMENT

Reference will now be made in detail to the preferred embodiment of the present invention, which is illustrated in the accompanying drawing.

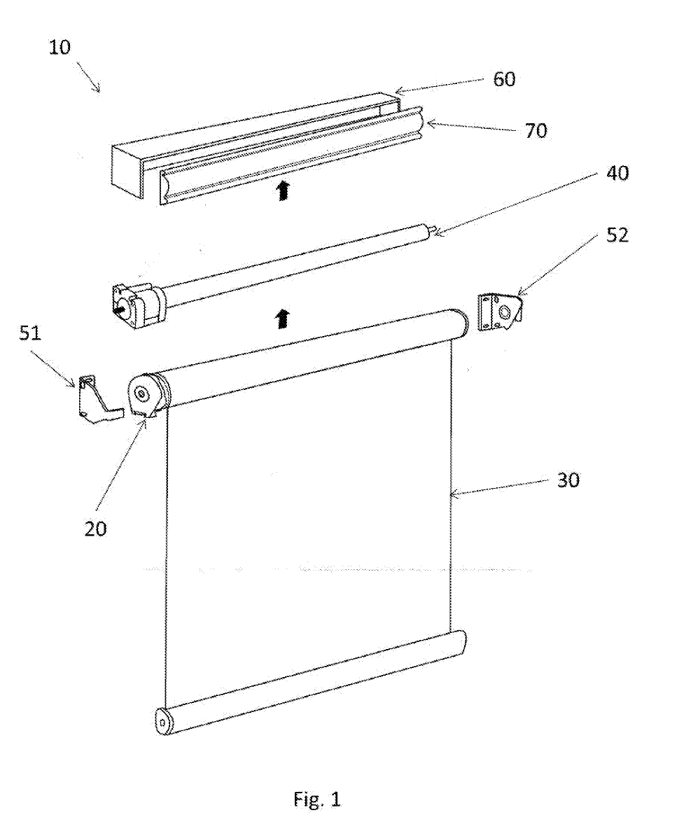

FIGS. 1-3 show a window covering assembly according to one embodiment of the present invention. As shown in FIG. 1, the window covering assembly 10 may include a roller 20, around which a window cover 30 is wound. Upon rotation of the roller 20, window cover 30 is either raised or lowered, depending on the direction of rotation of roller 20. In one embodiment, window cover 30 is a screen; however, other window coverings may be used. For example, cellular blinds, as are commonly known in the art, may be used. In case of cellular blinds, the blinds are not wound around roller 20. Rather, a string that is attached to the bottom of the blinds is wound around a spool. Upon rotation of the spool, the bottom of the string is either raised or lowered, depending on the direction of rotation of the spool. This, in turn, either raises or lowers the cellular blinds.

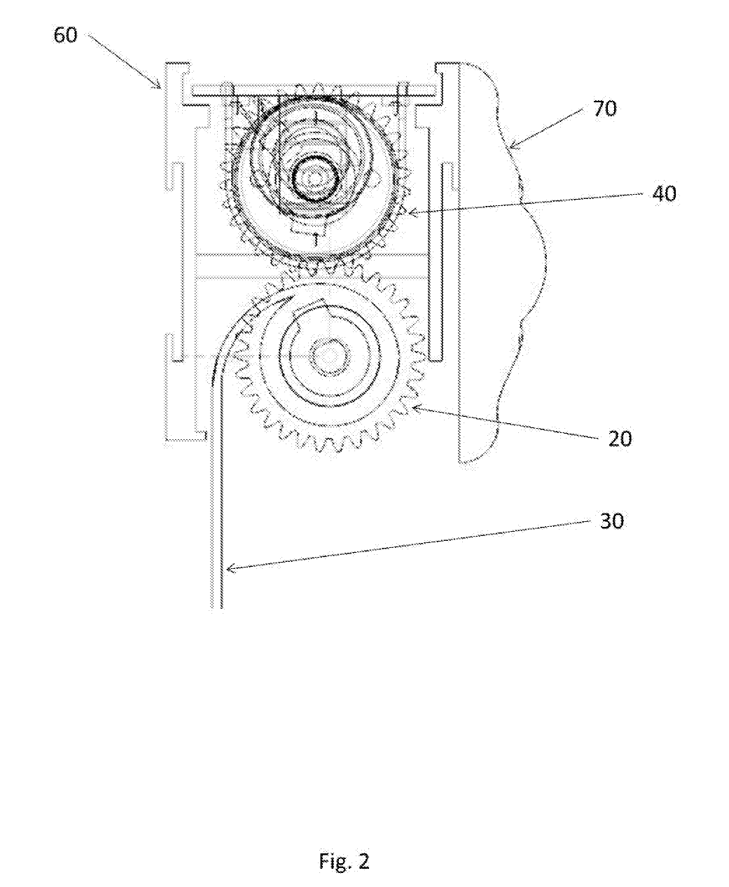

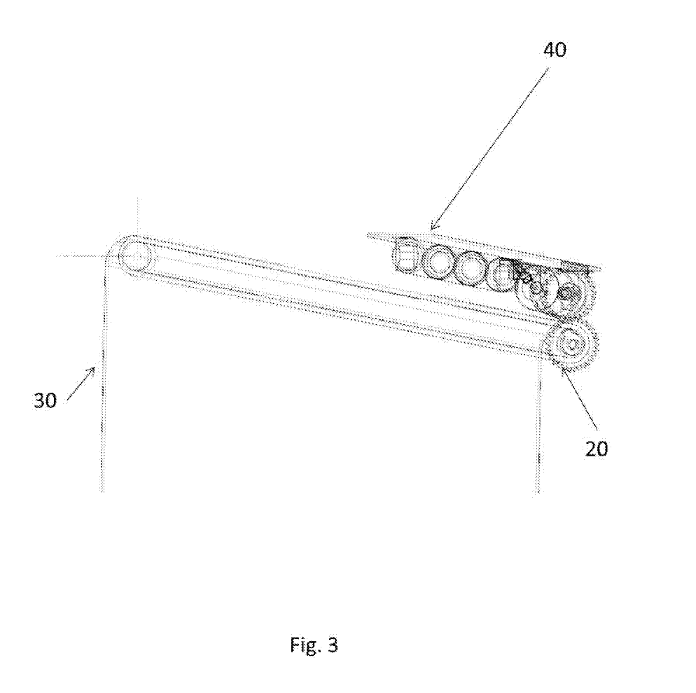

As is also shown in FIG. 1, the window covering assembly 10 may include a motor assembly 40. In one embodiment, this assembly includes a motor which, when activated, causes a shaft to rotate. As shown in FIGS. 2 and 3, this shaft may be connected to a spur gear that interfaces with a matching spur gear on the roller 20. In this way, the roller is caused to rotate and thereby raise or lower the window cover 30. The present invention is not limited to the power transmission system just described. Other gearing mechanisms may be used, and other power transmission systems, including chain drives and belt drives, may be used.

As is also shown in FIG. 1, the window covering assembly 10 may include mounting brackets 51, 52. In one embodiment, these mounting brackets secure the roller 20 and motor assembly 40 to a window frame. A roller channel 60 and valance 70 may be placed over the roller 20 and motor assembly 40 when the window covering assembly 10 is installed in a window frame. This visually obscures the roller 20 and motor assembly 40, increasing the aesthetic appearance of the window covering assembly 10.

In one embodiment of the present invention, one or more powered modules (not shown) may be attached to the window covering assembly 10. Exemplary powered modules include a light, temperature sensor, fan, heater, and motion detector. The window covering assembly 10 is configured to receive any configuration of these modules. This allows for a window covering assembly 10 with tailored features. For example, a window covering assembly 10 may include a motion detector and a light. Controls may be provided such that when a person walks in the vicinity of the window covering assembly, the light is turned on. As another example, a window covering assembly 10 may include a temperature sensor and a heater. Controls may be provided such that when the temperature sensor detects that the ambient temperature is below a certain threshold temperature, the heater is activated. It will be apparent to one of skill in the art that the preceding are only exemplary, and any combination of the powered modules may be employed in a window covering assembly 10.

In one embodiment, the modules are powered by a battery cell that is integral to the window covering assembly 10. This battery cell may also be the source of power for the motor assembly 40.

In one embodiment, all of the modules that may be installed on a window covering assembly 10 have the same outer profile, and the window covering assembly has receptacles configured to receive the modules. In this way, any module may be placed in any of the receptacles of the window covering assembly 10.

It will be apparent to those skilled in the art that various modifications and variations can be made in the modular motorized window blinds assembly of the present invention without departing from the spirit or scope of the invention. Thus, it is intended that the present invention cover modifications and variations of this invention provided they come within the scope of the appended claims and their equivalents.

What is claimed is:

1. A window covering assembly comprising:
a roller;
a motor assembly;
a window cover; and
a powered module, wherein
the window cover is attached to the roller,
the window cover is raised when the roller rotates in a first angular direction,
the window cover is lowered when the roller rotates in a second angular direction, opposite the first angular direction,
the motor assembly interfaces with the roller via a power transmission system.

2. The window covering assembly according to claim 1, wherein the powered module is one of a light, a temperature sensor, a fan, a heater, and a motion sensor.

3. The window covering assembly according to claim 1, further comprising a plurality of powered modules.

4. The window covering assembly according to claim 1, wherein the powered modules receive power from a battery cell that is integral to the window covering assembly.

5. The window covering assembly according to claim 1, wherein the window covering assembly comprises one or more receptacles configured to receive the powered module.
